(19) United States
(12) Patent Application Publication
(10) Pub. No.: US 2014/0292457 A1
(43) Pub. Date: Oct. 2, 2014

(54) REACTOR

(71) Applicant: Toyota Jidosha Kabushiki Kaisha, Toyota-shi Aichi-ken (JP)

(72) Inventors: Nobuki Shinohara, Toyota-shi Aichi-ken (JP); Mao Nobusaka, Ohbu-shi Aichi-ken (JP)

(73) Assignee: Toyota Jidosha Kabushiki Kaisha, Toyota-shi Aichi-ken (JP)

(21) Appl. No.: 14/224,664

(22) Filed: Mar. 25, 2014

(30) Foreign Application Priority Data
Mar. 27, 2013 (JP) 2013-066793

(51) Int. Cl. H01F 27/28; H01F 27/255

(52) U.S. Cl. CPC H01F 27/2876; H01F 27/255
USPC 336/83

(57) ABSTRACT

A reactor includes a core, and a coil, in which a projected shape of the coil in projection in a winding axis direction is a rectangle. The coil is embedded in the core. The coil is exposed an outer peripheral side of one of long sides of the rectangle of the coil from the core.

### INCORPORATION BY REFERENCE

The disclosure of Japanese Patent Application No. 2013-066793 filed on Mar. 27, 2013 including the specification, drawings and abstract is incorporated herein by reference in its entirety.

### BACKGROUND OF THE INVENTION

1. Field of the Invention

The present invention relates to a reactor.

2. Description of Related Art

As this type of a reactor, a reactor has been proposed, which includes a coil having a plurality of curved parts and straight parts, the curved parts having a curved projected shape and the straight parts having a linear shape in projection in a winding axis direction. The reactor also includes a core, in which a part of the coil is embedded, the core being made of a magnetic powder mixed resin that structures a magnetic path of magnetic flux. At least parts of the curved parts of the coil are exposed from the core (for example, see Japanese Patent Application Publication No. 2010-283119 A (JP 2010-283119 A)). In this reactor, at least parts of the curved parts, which are likely to have a high magnetic flux density in the coil, are exposed from the core. Thus, non-uniformity of a magnetic flux density is restrained.

### SUMMARY OF THE INVENTION

In the reactor disclosed in JP 2010-283119 A, since the parts that are likely to have a high magnetic flux density are exposed from the core, there is a problem that inductance is reduced. To be able to cool the coil more sufficiently is described as another issue in such a reactor.

A reactor according to the present invention provides a structure that realizes a small reduction of inductance while ensuring cooling performance for a coil.

A reactor according to an aspect of the present invention includes a core, and a coil, in which a projected shape of the coil in projection in a winding axis direction is a rectangle, and the coil is embedded in the core, and expose an outer peripheral side of one of long sides of the rectangle of the coil from the core.

In the reactor according to the aspect of the present invention, the coil is formed so that the outer periphery of one of the long sides of the rectangle is exposed from the core. Therefore, it is possible to cool the coil more sufficiently (ensure cooling performance). Compared to a coil that is formed so that an outer peripheral side of one of short sides of a rectangle is exposed from a core, it is possible to prevent a magnetic path from becoming long, and restrain a reduction of inductance. In other words, it is possible to have a structure that realizes a small reduction of inductance while ensuring cooling performance for a coil.

In the reactor according to the aspect of the present invention, the coil may be configured so that outer peripheral sides of rest of three sides, other than the long side of the rectangle of the coil, are embedded in the core. This way, a reduction of an effective sectional area of the core (a sectional are through which magnetic flux passes) is restrained.

In the reactor according to the aspect of the present invention, the core may include a magnetic powder mixed resin. This way, effects are obtained such as making the core gapless due to small magnetic permeability, and increasing a sectional area of the core because the magnetic powder mixed resin is closely adhered to the entire coil.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a structural view schematically showing a structure of a reactor as an example of the present invention;

FIG. 2 is a II-II view of the reactor shown in FIG. 1, taken along a II-II surface;

FIG. 3 is a III-III view of the reactor shown in FIG. 1, taken along a III-III surface;

FIG. 4 is a structural view schematically showing a structure of a reactor according to a first comparative example;

FIG. 5 is a structural view schematically showing a structure of a reactor according to a second comparative example; and

FIG. 6 is a structural view schematically showing a structure of a reactor according to a third comparative example.

### DETAILED DESCRIPTION OF EMBODIMENTS

Next, an embodiment for carrying out the present invention is explained by using an example.

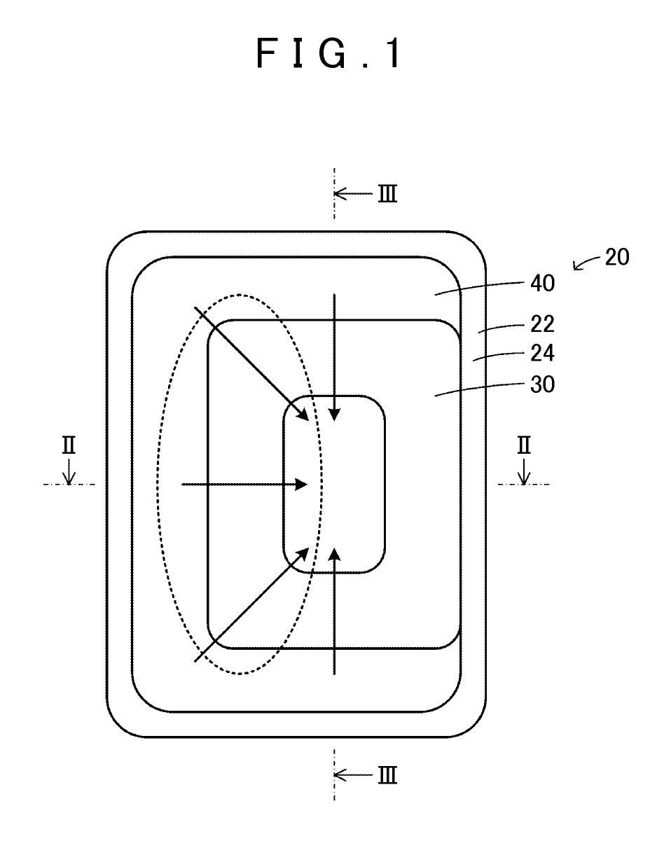

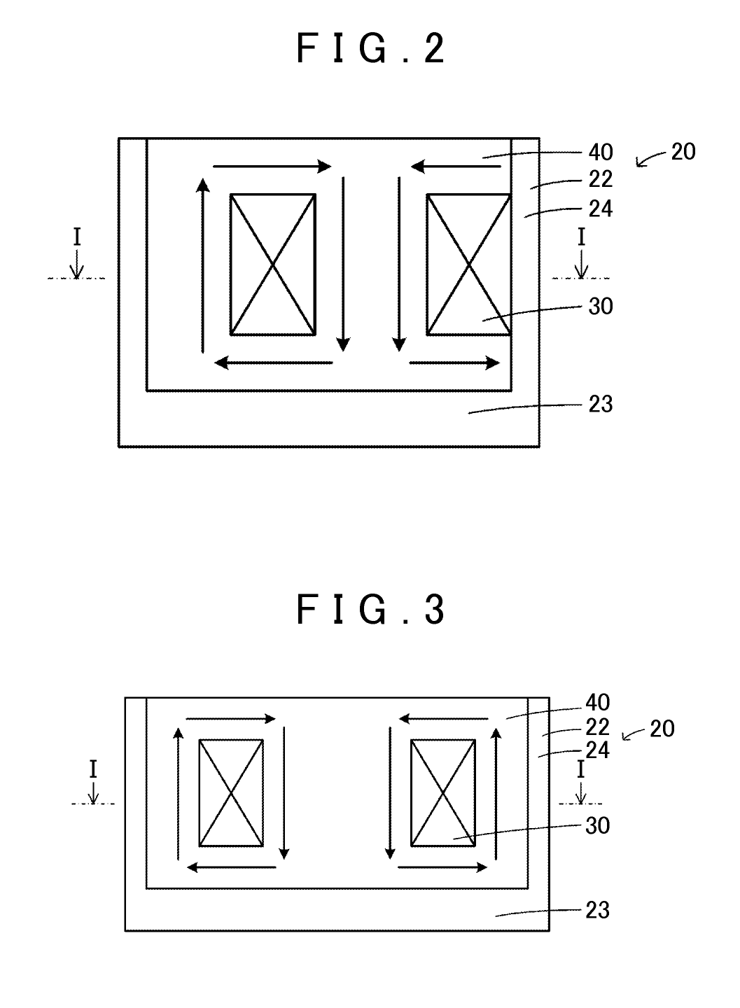

FIG. 1 is a structural view schematically showing a structure of a reactor as an example of the present invention, FIG. 2 is a II-II view of the reactor shown in FIG. 1, taken along a II-II surface, and FIG. 3 is a III-III view of the reactor shown in FIG. 1, taken along a III-III surface. FIG. 1 corresponds to a I-I view from a I-I surface of the reactor shown in FIG. 2 and a I-I view from a I-I surface of the reactor shown in FIG. 3. Although arrows in FIG. 1 to FIG. 3 show an example of a direction of magnetic flux, the arrows in FIG. 1 correspond to the arrows of magnetic flux on an upper side of the coil in FIG. 2 and FIG. 3 (the arrows directed towards the center of axis of the coil) as a matter of convenience.

A reactor 20 is structured as a part of a boost converter that boosts voltage from a battery and supplies the voltage to a motor side. The reactor 20 is formed in a generally rectangular parallelepiped shape as a whole, and includes a coil 30 housed in a case 22, and a core 40 in which the coil 30 is embedded inside the case 22, as shown in FIG. 1 to FIG. 3. The reactor 20 (particularly the coil 30) is cooled by exchanging heat with a cooling medium of a cooler (not shown) arranged on an outer side of the case 22.

The case 22 is formed of, for example, aluminum, and includes a rectangular bottom part 23, and a side surface part 24 having a hollow quadrangular prism shape and extending from an outer periphery of the bottom part to an upper side in FIG. 2 and FIG. 3.

The core 40 is structured by filling and forming a magnetic powder mixed resin in the case 22. The magnetic powder mixed resin is made by mixing, for example, magnetic powder such as ferrite powder, iron powder, and silicon-iron alloy powder, into a resin such as a thermosetting resin and a thermoplastic resin. By using the magnetic powder mixed resin as above, effects are obtained such as making the core 40 gapless due to small magnetic permeability, and increasing a sectional area of the core 40 because the magnetic powder mixed resin is closely adhered to the entire coil 30.

The coil 30 is structured as a conductive wire, which is formed by, for example, coating a copper conductor with an insulating material such as enamel, is formed in a generally helical shape. The coil 30 is formed so that a projected shape of the coil 30 in projection in a winding axis direction is a rectangular shape (the coil 30 has a hollow quadrangular prism shape as a whole). The coil 30 is arranged so that an outer peripheral side of one of long sides of the rectangular projected shape of the coil 30 in projection in the winding axis direction is exposed from the core 40, and is in contact with an inner periphery of the side surface part 24 of the case 22, and outer peripheral sides of the rest of three sides are covered by the core 40. The reason why the coil 30 is formed to have a rectangular projected shape in projection in the winding axis direction (the coil 30 has the hollow quadrangular prism shape as a whole) is because a space is used more effectively, and the surface exposed from the core 40 becomes a larger plane, compared to a coil formed to have a circular projected shape in projection in the winding axis direction (the coil has a hollow circular shape as a whole). The coil 30 generates magnetic flux when energized (see the arrows in FIG. 1 to FIG. 3).

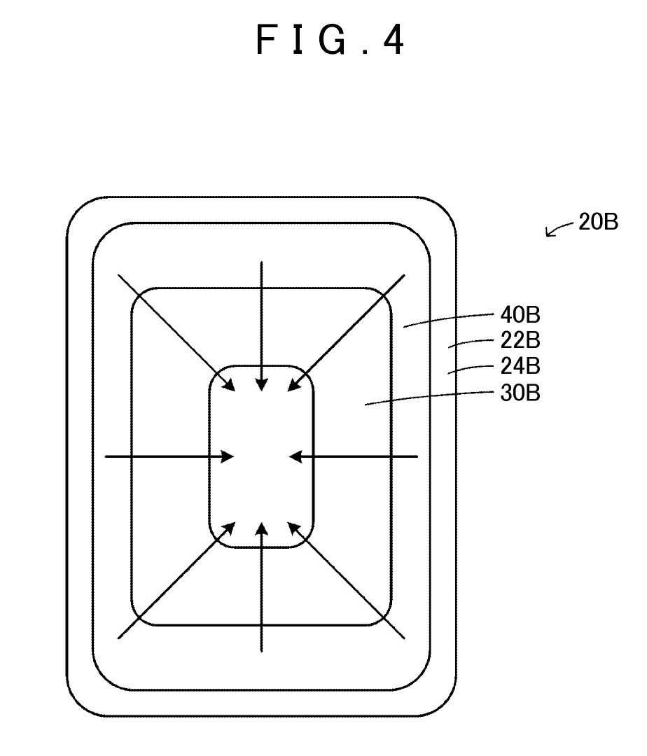

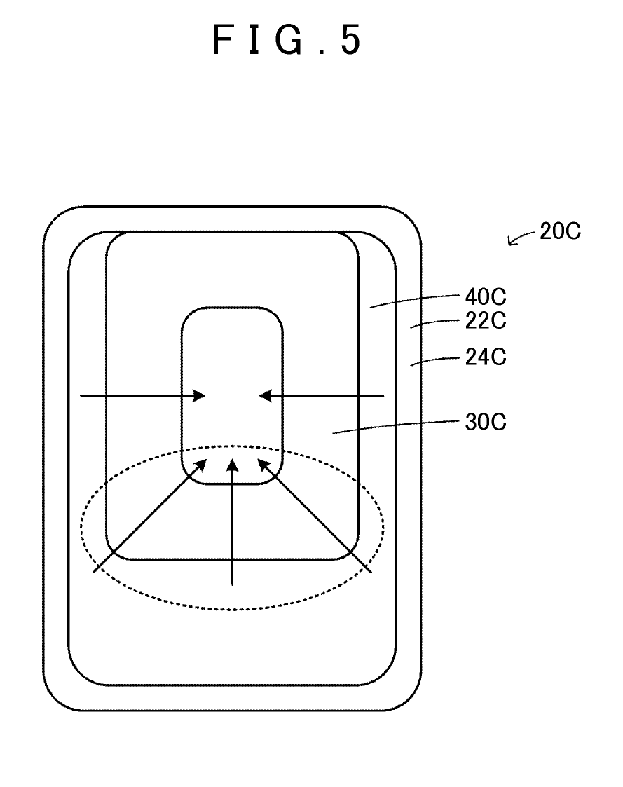

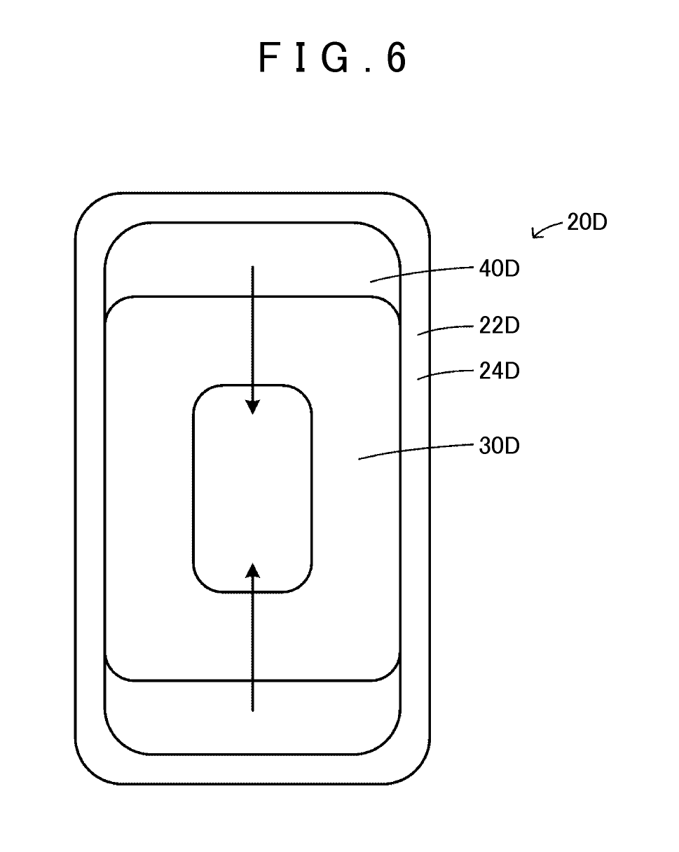

FIG. 4 is a structural view schematically showing a structure of a reactor 20B according to a first comparative example, FIG. 5 is a structural view schematically showing a structure of a reactor 20C according to a second comparative example, and FIG. 6 is a structural view schematically showing a structure of a reactor 20D according to a third comparative example. In FIG. 4, FIG. 5, and FIG. 6, arrows show an example of a direction of magnetic flux. In the first comparative example in FIG. 4, a structure is considered, in which the coil 30B is entirely embedded in a core 40B (in the coil 30B, none of outer peripheral sides of any sides of a rectangular projected shape in a winding axis direction are exposed from the core 40B, nor in contact with inner periphery of a side surface part 24B of a case 22B). In the second comparative example in FIG. 5, a structure is considered, in which the coil 30C is arranged so that an outer peripheral side of a short side of a rectangular projected shape in a winding axis direction is exposed from a core 40C, and is in contact with an inner periphery of a side surface part 24C of a case 22C. In the third comparative example in FIG. 6, a structure is considered, in which a coil 30D is arranged so that outer peripheral sides of both of two long sides of a rectangular projected shape in a winding axis direction are exposed from a core 40D, and are in contact with inner peripheries of side surface parts 24D of a case 22D. The arrows in FIG. 4, FIG. 5, and FIG. 6 correspond to the arrows in FIG. 1.

First of all, the first comparative example in FIG. 4 is compared to the example, and the second comparative example in FIG. 5. In the case of the first comparative example in FIG. 4, since the coil 30B is embedded entirely in the core 40B, there is a problem that heat exchange between the coil 30B and a cooling medium of a cooler outside of the case 22 might be slightly insufficient (there is a room for improvement). On the other hand, in the example and the second comparative example in FIG. 5, in the coils 30, and 30C, the outer peripheral sides of the long side and short side of the rectangular projected shapes in projection in the winding axis direction are exposed from the cores 40, 40C, and are in contact with the inner peripheries of the cases 22, 22C, respectively. Therefore, it is possible to exchange heat more sufficiently between the coils 30, 30C, and the cooling media of the coolers outside the cases 22, 22C, respectively, thereby improving cooling performance for the coils 30, 30C. In the example, an area that is in contact with the case 22 is larger than that of the second comparative example. Therefore, cooling performance for the coil 30 is improved further.

Next, the example is compared to the second comparative example in FIG. 5. In general, inductance L of a reactor is obtained by the following equation (1) by using a number of turns N of a coil, magnetic permeability μ of a core, an effective sectional area of a core (an area of a section through which magnetic flux passes) S, and a length l of a magnetic path. In order to minimize waste in a design of a reactor, it is preferred that the length l of the magnetic path is reduced as much as possible to increase the inductance L. The following was found out from experiments and analysis: in the case of a structure like the second comparative example in FIG. 5, a magnetic path becomes long around a short side that is embedded in the core 40C (a part surrounded by a broken line in FIG. 5) out of the short sides of the rectangle. Therefore, an effective sectional area of the core 40 is reduced, and an extent of a reduction of inductance of the reactor 20C is relatively large with respect to the first comparative example in FIG. 4. Meanwhile, in the case of the structure as the example in FIG. 1, a magnetic path does not become so long around a long side that is embedded in the core 40 (a part surrounded by a broken lone in FIG. 1) out of the long sides of the rectangle. Therefore, an effective sectional area of the core 40 is ensured, and an extent of a reduction of inductance of the reactor 20 is lowered with respect to the first comparative example in FIG. 4, compared to the second comparative example.

$$\begin{matrix}[ Equation 1 ] & \\ L = \frac{μ \cdot {N}^{2} \cdot S}{𝓁} & ( 1 )\end{matrix}$$

The example is compared to the third comparative example in FIG. 6. In the case of the third comparative example in FIG. 6, since the outer peripheral sides of both of the two long sides of the rectangle are exposed from the core 40D, an extent of a reduction of an effective sectional area of the core 40D (an area of a section through which magnetic flux passes) with respect to the first comparative example in FIG. 4 is relatively large, and thus an extent of a reduction of inductance of the reactor 20D is relatively large. On the other hand, in the case of the structure of the example in FIG. 1, only the outer peripheral side of one of the long sides of the rectangle is exposed from the core 40, and the outer peripheral sides of the rest of the three sides are covered by the core 40. Therefore, an effective sectional area of the core 40 is ensured, and an extent of a reduction of inductance of the reactor 20 with respect to the first comparative example in FIG. 4 is relatively small compared to third comparative example.

With these reasons, in the example, the outer peripheral side of one of the long sides of the rectangular projected shape of the coil 30 in projection in the winding axis direction is exposed from the core 40, and is in contact with the inner periphery of the side surface part 24 of the case 22.

According to the reactor 20 in the example explained so far, since the outer peripheral side of one of the long sides of the rectangular projected shape of the coil 30 in projection in the winding axis direction is exposed from the core 40, and is in contact with the inner periphery of the side surface part 24 of the case 22. Therefore, the structure of the reactor 20 realizes a small reduction of inductance while ensuring cooling performance for the coil 30.

In the reactor 20 of the example, the core 40 is formed of a magnetic powder mixed resin, but may be formed of a different material. For example, the reactor 20 may be formed as a powder magnetic core.

Correspondence between main elements of the example and main elements of the invention stated in the section “Summary of the invention” is explained. In the example, the coil 30 corresponds to a “coil”, and the core 40 corresponds to a “core”.

The correspondence between the main elements of the example, and the main elements of the invention stated in the section “Summary of the invention” is an example for specifically explaining an embodiment in which the invention stated in the section “Summary of the invention” is carried out by the example. Thus, the correspondence does not limit the elements of the invention stated in the section “Summary of the invention”. In other words, interpretation of the invention stated in the section “Summary of the invention” should be made based on the description in that section, and the example is only a specific example of the invention stated in the section “Summary of the invention”.

The embodiment for carrying out the present invention has been explained by using the example. However, the present invention is not limited to such an example at all, and may be carried out in various forms without departing from the gist of the present invention, as a matter of course.

The present invention is applicable to a manufacturing industry of reactors, and so on.

What is claimed is:

1. A reactor comprising:
a core; and
a coil, in which a projected shape of the coil in projection in a winding axis direction is a rectangle, the coil embedded in the core, and the coil exposed an outer peripheral side of one of long sides of the rectangle of the coil from the core.

2. The reactor according to claim 1, wherein the coil is configured so that outer peripheral sides of rest of three sides, other than the long side of the rectangle of the coil, are embedded in the core.

3. The reactor according to claim 1, wherein the core includes a magnetic powder mixed resin.
